(19) United States
(12) Patent Application Publication
(10) Pub. No.: US 2011/0225225 A1
(43) Pub. Date: Sep. 15, 2011

(54) METHOD, PROGRAM, AND SYSTEM FOR SOLVING ORDINARY DIFFERENTIAL EQUATION

(75) Inventors: Arquimedes Martinez Canedo, Tokyo (JP); Hideaki Komatsu, Kanagawa-ken (JP); Takeo Yoshizawa, Kanagawa-ken (JP)

(73) Assignee: INTERNATIONAL BUSINESS MACHINES CORPORATION, Armonk, NY (US)

(21) Appl. No.: 13/045,866

(22) Filed: Mar. 11, 2011

(30) Foreign Application Priority Data
Mar. 11, 2010 (JP) 2010-054251

(51) Int. Cl. G06G 7/38

(52) U.S. Cl. 708/804

(57) ABSTRACT

Each ordinary differential equation of simultaneous ordinary differential equations is solved with an embedded Runge-Kutta method. A difference Δ between an N-th order approximation and an (N+1)th order approximation is computed, and it is determined whether the difference is smaller than a predetermined threshold Δ₀. If Δ≦Δ₀, then a step size is determined using a predetermined computation formula containing Δ₀/Δ, and then the process proceeds to next computation. A strand having an error of Δ>Δ₀ is directed to execute recomputation using a step size calculated based on Δ₀/Δ. Then the strand having the error executes recomputation by using a computed interpolated value. When the strand's error becomes smaller than the threshold Δ₀ the strand reaches the same time step as the strands computing the other ordinary differential equations having no error. The process thereby proceeds to next computation of the whole simultaneous ordinary differential equations.

### CROSS-REFERENCE TO RELATED APPLICATION

This application claims priority under 35 U.S.C. §119 to Japanese Patent Application No. 2010-54251 filed Mar. 11, 2010, the entire contents of which are incorporated herein by reference.

### BACKGROUND OF THE INVENTION

1. Field of the Invention

The present invention relates to a method, an article of manufacture, and a system for solving an ordinary differential equation employed in a simulation system or the like using a computer. More particularly, the present invention relates to a technique for reducing the time or amount of computation required for solving an ordinary differential equation.

2. Description of Related Art

Computers have been heretofore used in fields such as scientific computation and simulation.

A simulation technology has been significantly developed these days. Simulation systems use software for simulation in mechatronics plants of a robot, a vehicle, an airplane, and the like. The development in electronic components and software technology has enabled electronic control of a major part of a machine, such as a robot, a vehicle, or an airplane by using a wireless LAN, wire connections spread over the machine as if nerves are, and the like.

Although such a machine is fundamentally a mechanical device, it has massive control software installed therein. Accordingly, in product development, a great amount of time, huge cost, and a lot of people are required for the development of control programs and tests of the programs.

Hardware in the loop simulation (HILS) is a technique that has been conventionally used for such tests. In particular, an environment for testing electronic control units (ECU) of an entire vehicle is called full-vehicle HILS. In full-vehicle HILS, actual ECUs are connected to a dedicated hardware device for emulating an engine mechanism and a transmission mechanism, for example, in a laboratory. Tests are then carried out according to predetermined scenarios. Outputs from the ECUs are inputted to a monitoring computer, and are then displayed on a display. Thus, the test operator checks for any abnormal operation while looking at the display.

In recent years, a technique using software without using any expensive emulation hardware device, called software in the loop simulation (SILS), has been proposed. In SILS, plants such as microcomputers mounted in the ECU, input/output circuits, control scenarios, engines, transmissions, and the like are all emulated by a software simulator. By use of this technique, a test can be carried out without using actual ECU hardware.

An example of a system for supporting implementation of SILS is MATLAB®/Simulink®, which is a simulation modeling system available from The MathWorks, Inc. By using MATLAB®/Simulink®, a simulation program can be created by arranging functional blocks indicated by rectangles on a display through a graphical interface, and then specifying process flows as shown by arrows in FIG. 1.

The block diagram represents a process in one time-step of the simulation. Time-series behaviors of a system to be simulated can be obtained by iterative execution of this process a predetermined number of times. When a block diagram including the functional blocks and the like is created by MATLAB®/Simulink®, each function can be transformed into source code describing an equivalent function in a known computer language, such as C language, by a function of Real-Time Workshop®. By compiling the C source code, a simulation can be performed as SILS in a different computer system.

As shown in FIG. 2, a technique has been heretofore employed in which the functional blocks are classified into several groups, such as A, B, C, and D, and the groups are subjected to computation by a CPU.

In this way, it is possible to compile source code for each group of functional blocks to create executable code, and to execute the executable code on the processor.

In many cases, running such executable code on a computer system to obtain a simulation result is eventually equivalent to causing the computer system to solve differential equations. In mechatronics systems such as a vehicle and a robot, in particular, differential equations to be solved are written as ordinary differential equations such as ones used in a response system of electric circuits, a feedback control system of electronic circuits, and equations for mechanical dynamics. Accordingly, it is necessary to cause the computer system to solve simultaneous ordinary differential equations in order to obtain the simulation result. Such simultaneous ordinary differential equations are formulated as follows:

y′(t)=f(t,y(t))

where t denotes time, y′(t) denotes first-order differentiation with respect to time t, and y and f generally denote n-dimensional vectors and are thus represented as follows:

y(t)≡(y^{[1]}(t),y^{[2]}(t), . . . ,y^{[N]}(t))^{T}, and

f(t,y(t))≡(f^{[1]}(t,y(t)),f^{[2]}(t,y(t)), . . . ,f^{[N]}(t,y(t)))^{T}.

These can also be written as y, fεR^{N}.

In other words, the above equation is the following simultaneous ordinary differential equations when expressed separately:

y′^{[1]}(t)=f^{[1]}(t,y(t)),

y′^{[2]}(t)=f^{[2]}(t,y(t)),

y′^{[3]}(t)=f^{[3]}(t,y(t)),

. . . , and

y′^{[N]}(t)=f^{[N]}(t,y(t)).

Typically, the code for one group of functional blocks described above corresponds to the right-hand side of one equation y′^{[i]}(t)=f^{[i]}(t,y(t)) (i=1, . . . , N). In this specification, this computation process unit is referred to as a strand.

In order to achieve faster simulation, there is a strong demand for employing a computation algorithm with a more reasonable amount of computation as well as using a high-performance computer.

In this regard, a Runge-Kutta method, which was devised in 1900, is known as an algorithm for obtaining approximate solutions of ordinary differential equations through numerical computation by a computer. This method employs a fixed computation step size, and thus its computation accuracy is insufficient for some applications.

Thereafter, the Runge-Kutta-Fehlberg method employing an adaptively variable step size was devised in the 1960s in order to satisfy both computation accuracy and speed. The Runge-Kutta-Fehlberg method is described here on the assumption that y′(t)=f(t, y(t)) involves one variable, for the sake of convenience of description. In other words, both y(t) and f(t, y(t)) are scalars here.

The scheme known as ODE45 is particularly described as an example of the Runge-Kutta-Fehlberg method. Here, ODE is an abbreviation of ordinary differential equation.

k₁=hf(xₙ,yₙ)

k₂=hf(xₙ+a₂h,yₙ+b₂₁k₁)

k₃=hf(xₙ+a₃h,yₙ+b₃₁k₁+b₃₂k₂)

k₄=hf(xₙ+a₄h,yₙ+b₄₁k₁+b₄₂k₂+b₄₃k₃)

k₅=hf(xₙ+a₅h,yₙ+b₅₁k₁+b₅₂k₂+b₅₃k₃+b₅₄k₄)

k₆=hf(xₙ+a₆h,yₙ+b₆₁k₁+b₆₂k₂+b₆₃k₃+b₆₄k₄+b₆₅k₅)

$${y}_{n + 1} = {y}_{n} + {\sum }_{i = 1}^{6} {c}_{i} {k}_{i} + O ( {h}^{6} ) \\ {y}_{n + 1}^{*} = {y}_{n} + {\sum }_{i = 1}^{6} {c}_{i}^{*} {k}_{i} + O ( {h}^{5} ) \\ Δ ≡ {y}_{n + 1} - {y}_{n + 1}^{*} = {\sum }_{i = 1}^{6} ( {c}_{i} - {c}_{i}^{*} ) {k}_{i} \\ {h}_{0} = h {\vert \frac{{Δ}_{0}}{Δ} \vert}^{0.2} \qquad [ Mathematical Formula 1 ]$$

where Xₙ denotes time, kᵢ (i=1, . . . , 6) denotes an intermediate variable, h denotes a step size (here, h is not a constant but a variable), and aᵢ, bᵢⱼ, cᵢ, and c*ᵢ (here, i and j are suffixes) are predetermined constants.

In the Runge-Kutta-Fehlberg method, in order to keep computation accuracy within a desired range, it is determined whether or not an error Δ computed in the above manner falls to or below a predetermined threshold Δ₀, and if so, a step size h₀ is computed with the above formula and is set as the step size of the next loop iteration.

If the error Δ computed in the above manner exceeds the predetermined threshold Δ₀, on the other hand, the computation is regarded as an error in the Runge-Kutta-Fehlberg method, and thus the currently used step size h is changed to a smaller step size for recomputation.

In the case of the simultaneous ordinary differential equations y′(t)=f(t, y(t)), y, fεRⁿ, however, y(t) actually includes y^{[1]}(t), y^{[2]}(t), . . . , y^{[n]}(t). For this reason, even if the above error occurs only in y′^{[1]}(t)=f^{[i]}(t, y(t)) (where i is a certain number between 1 and n), for example, the entire equations y′(t)=f(t, y(t)), y, fεR^{N} need to be recomputed. Such recomputation of the entire equations y′(t)=f(t, y(t)) causes huge overhead if the recomputation occurs many times or if the total amount of computation is large.

Japanese Patent Application Publication No. Hei 5-334337 discloses the following method of parallel processing ordinary differential equations under a multi-processor environment. Specifically, multiple processors are respectively assigned different initial step sizes. Each of the processors obtains an approximate solution in its numerical-value integration part, obtains a local error in its local-error computation part, and obtains an allowable error in its allowable-error computation part. Each processor then adjusts the currently-set step size in its step-size adjustment part on the basis of a relation between the two errors. Along with this adjustment, an evaluation device selects the largest step size among those used for processes in the multiple processors, and re-sets the selected step size in all the processors.

W. H. Enright, K. R. Jackson, S. P. Norsett, P. G. Thomsen, “Interpolants for Runge-Kutta formulas” ACM Transactions on Mathematical Software, Volume 12, Issue 3 (September 1986) (Non-patent Literature 1) describes a method of forming an interpolant with the Runge-Kutta method and the Runge-Kutta-Fehlberg method.

### SUMMARY OF THE INVENTION

The above conventional techniques describe the technique for computing a step size or the amount of interpolation in computation of ordinary differential equations by means of a computer. However, these techniques suggest nothing for reducing the amount of computation for solving simultaneous ordinary differential equations in accordance with the Runge-Kutta method or the Runge-Kutta-Fehlberg method.

Hence, an object of the present invention is to provide a technique for reducing the amount of computation in a computation process for solving simultaneous ordinary differential equations used in a simulation system or the like by means of a computer.

The present invention has been made to solve the above problem, and in one aspect uses the following method to allow reduction in the amount of computation of simultaneous ordinary differential equations executed by a computer.

In a first aspect, the present invention is a method of solving ordinary differential equations using a Runge-Kutta method. Specifically, when each ordinary differential equation of a simultaneous ordinary differential equations is solved, a difference Δ between an N-th order approximation (where N is a given integer) and an (N+1)th order approximation is computed, and it is determined whether or not the difference is smaller than a predetermined threshold Δ₀. If the difference Δ between the N-th order approximation and the (N+1)th order approximation is larger than the threshold Δ₀, only a strand computing an ordinary differential equation having an error of Δ>Δ₀ is recomputed. For recomputation, a step size is calculated based on the error and the threshold. In order to further advance the time step of the strand with the error up to the time step of other strands which execute no recomputation, an interpolated value corresponding to the computed steps size is calculated. Finally, the ordinary differential equation strand with the error is recomputed using the computed step size and interpolated values.

In a second aspect, an article of manufacture tangibly embodying computer readable instructions is used to solve simultaneous ordinary differential equations through a Runge-Kutta method. For each ordinary differential equation, the instructions cause the computer to compute an error between a state value of order N (where N is a given integer) and a state value of order N+1. When an error exceeds a predetermined threshold, the instructions cause the computer compute a step size by using the error and the threshold for the ordinary differential equation. The instructions also cause the computer to compute an interpolated value corresponding to the computed step size for each of the ordinary differential equations associated with the ordinary differential equation having the error exceeding the predetermined threshold. Finally, the instructions cause the computer to recompute the ordinary differential equation having the error exceeding the predetermined threshold by using the computed step size and the computed interpolated value.

In a third aspect, a system for solving simultaneous ordinary differential equations by using an embedded Runge-Kutta method on a computer is described. The system includes a means for computing an error between a state value of order N (where N is a given integer) and a state value of order N+1 for each of ordinary differential equations of the simultaneous ordinary differential equations; when an error exceeds a predetermined threshold, a means for computing a step size by using the error and the threshold for the ordinary differential equation; a means for computing an interpolated value corresponding to the computed step size for each of the ordinary differential equations having the error exceeding the predetermined threshold; and a means for recomputing the ordinary differential equation having the error exceeding the predetermined threshold through the process of the computer by using the computed step size and the computed interpolated value.

### BRIEF DESCRIPTION OF THE DRAWINGS

FIG. 1 illustrates a diagram showing functional blocks according to an embodiment of the current invention.

FIG. 2 illustrates a diagram showing formation of strands out of the functional blocks according to an embodiment of the current invention.

FIG. 3 illustrates a block diagram showing a hardware configuration according to an embodiment of the current invention.

FIG. 4 illustrates a functional block diagram of a logic structure according to an embodiment of the current invention.

FIG. 5 illustrates a schematic flowchart showing steps for parallel computation of simultaneous ordinary differential equations according to an embodiment of the current invention.

FIG. 6 illustrates a flowchart showing a process for solving an ordinary differential equation by means of a process in which the present invention is applied to the scheme of ODE45 according to an embodiment of the current invention.

FIG. 7 illustrates a diagram showing a timing for interpolated values in the parallel computation of the simultaneous ordinary differential equations according to an embodiment of the current invention.

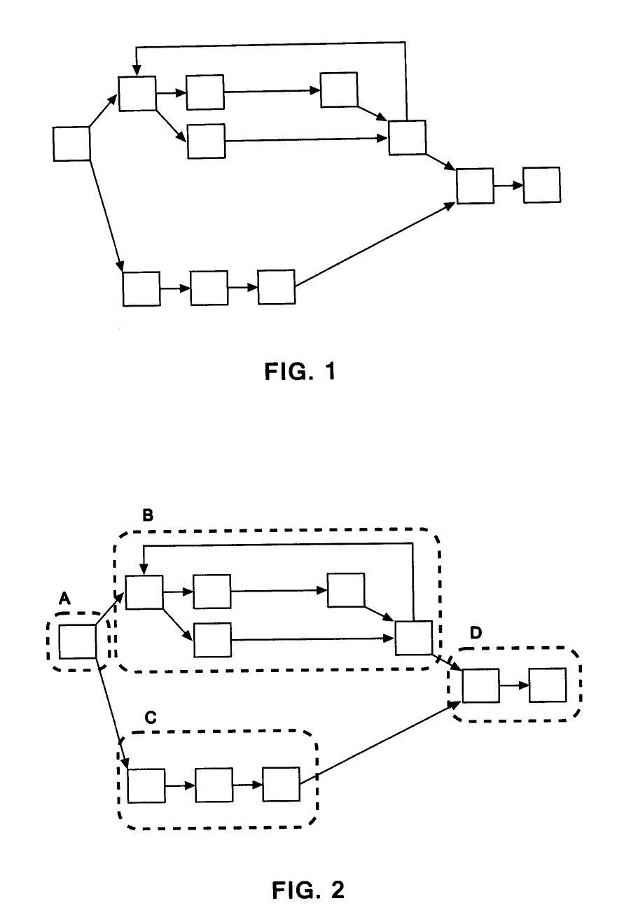

### DETAILED DESCRIPTION OF THE PREFERRED EMBODIMENTS

The basic principle of the invention is computing simultaneous ordinary differential equations in accordance with an embedded Runge-Kutta method such that a computer has only to execute recomputation of a strand in which an error larger than a threshold has occurred. This reduces the amount of computation, thus enabling a faster process.

Detailed description of the invention is made in combination with the following embodiments. In the following description, the same components are denoted by the same reference numerals throughout the drawings unless otherwise noted. In addition, the following configuration and the process are described merely as an embodiment of the present invention. Thus, it is to be understood that the technical scope of the present invention is not intended to be limited to this embodiment.

In a first aspect, the present invention is based on a method of solving ordinary differential equations through numerical computation by a computer using an embedded Runge-Kutta method such as the Runge-Kutta-Fehlberg method which has been described in the background art.

Specifically, when each ordinary differential equation of simultaneous ordinary differential equations is solved, a difference Δ between an N-th order approximation (where N is a given integer) and an (N+1)th order approximation is computed, and it is determined whether or not the difference is smaller than a predetermined threshold Δ₀.

If Δ=<Δ₀ is satisfied, a step size is determined in accordance with a predetermined computation formula containing Δ₀/Δ, and thus the process proceeds to next computation. This method is the same as a conventional method of computing simultaneous ordinary differential equations using the Runge-Kutta-Fehlberg method thus far.

However, a computation process of the present invention is different if the difference Δ between the N-th order approximation and the (N+1)th order approximation is larger than the threshold Δ₀. Specifically, according to the conventional technique, if an error occurs even in any one of the ordinary differential equations of the simultaneous ordinary differential equations, the process needs to go back to the previous time step to recompute the whole simultaneous ordinary differential equations with a smaller step size.

By contrast, according to the present invention, among strands computing ordinary differential equations of the simultaneous ordinary differential equations, only a strand computing an ordinary differential equation having an error of Δ>Δ₀ is directed to execute recomputation. For recomputation, a step size calculated based on Δ₀/Δ is newly set in the strand having the error, so that the time step of the strand is advanced by the amount determined by the step size.

In order to further advance its time step up to the time step of other strands which execute no recomputation, the strand needs values of computation results of other strands, associated with the strand, at the time of start of the time step of the strand.

These values are acquired not by re-execution of computation of the other strands executing no recomputation but by computation of interpolated values of the other strands between values in the previous time step and values in the last time step.

A computation algorithm suitable for computation of such an interpolated value for an ordinary differential equation is described in Non-patent Literature 1 above. However, a computation algorithm for an interpolated value usable in this embodiment is not limited to this, and any computation algorithm for an interpolated value satisfying desired accuracy can be used.

Through the recomputation using the acquired interpolated values, the error of the strand is kept smaller than the predetermined threshold Δ₀ in the strand executing computation of the ordinary differential equation, in which the error has occurred. At the same time, the time step of the strand is advanced to reach the time step of other strands with sufficiently small errors. Thereafter, the process proceeds to next computation of the whole simultaneous ordinary differential equations.

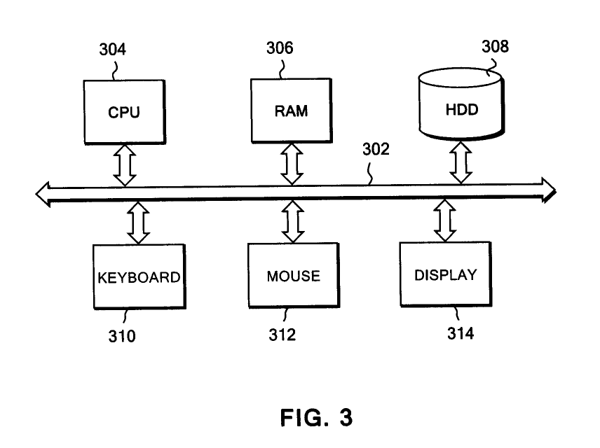

FIG. 3 shows a block diagram of computer hardware for realizing the system configuration and process according to an embodiment of the present invention.

In FIG. 3, a processor 304, a main memory (RAM) 306, a hard disk drive (HDD) 308, a keyboard 310, a mouse 312, and a display 314 are connected to a system bus 302. The processor 304 is preferably based on 32-bit or 64-bit architecture.

For example, Pentium (trademark) 4 of Intel Corporation, Core (trademark) 2 DUO of Intel Corporation, Athlon (trademark) of Advanced Micro Devices, Inc., or the like can be used as the processor 304. The main memory preferably has a capacity of 1 GB or larger, and more preferably has a capacity of 2 GB or larger.

The hard disk drive 308 stores therein an operating system. Any operating system compatible with the processor 304, such as Linux (trademark), Windows 7, Windows XP (trademark), Windows (trademark) 2000 of Microsoft Corporation, Mac OS (trademark) of Apple Computer, Inc., can be used as the operating system.

The hard disk drive 308 further stores therein MATLAB®/Simulink®, a C compiler or a C++ compiler, modules for parsing source code and forming strand according to the present invention, which will be described later, a module for generating code for processor assignment, and the like. These are each loaded into and executed by the main memory 306 in response to a keyboard operation or a mouse operation by the operator.

Here, the usable simulation modeling tool is not limited to MATLAB®/Simulink®, and any simulation modeling tool such as an open-source Scilab/Scicos can be used, for example.

Alternatively, in some cases, source code for the simulation system can be directly written in C or C++ directly without using any simulation modeling tool. The embodiment of the present invention is also applicable to such a case, if at least a part of the functions of the present invention can be written as computation of ordinary differential equations.

The keyboard 310 and the mouse 312 are used to initiate simulation or provide parameters for a certain equation through a graphical user interface provided by the operating system.

The display 314 is used to display as needed behaviors of simulation as solutions of simultaneous ordinary differential equations.

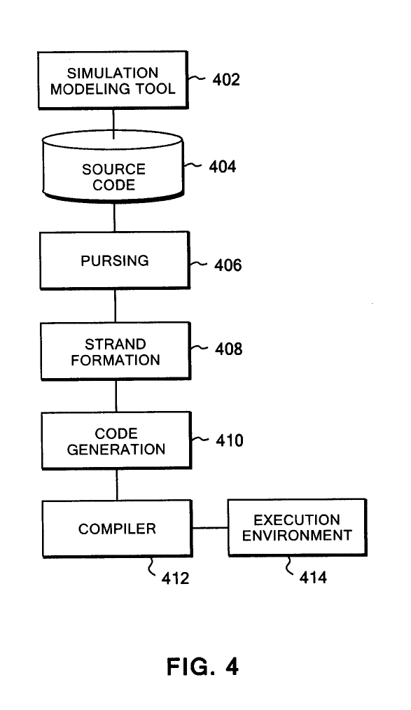

FIG. 4 is a functional block diagram according to the embodiment of the present invention. Each block is basically stored in the hard disk drive 308.

In FIG. 4, any existing modeling tool such as MATLAB®/Simulink® or Scilab/Scicos can be used as a simulation modeling tool 402. The simulation modeling tool 402 basically has such a function that enables the operator to arrange functional blocks on the display 314 through the GUI, to write required attributes such as mathematical formulae, and to describe a block diagram by associating the functional blocks with each other when necessary.

The simulation modeling tool 402 also has a function of outputting C source code describing equivalent functions to the described block diagram. The simulation modeling tool 402 can use C++, Fortran, or the like in place of C, and particularly can generate a MDL file, which has a proprietary format of Simulink®, to describe the dependence among functional blocks.

Note that the simulation modeling tool can be installed in another personal computer, so that source code generated in the personal computer can be downloaded to the hard disk drive 308 through a network, for example.

Source code 404 thus outputted is stored in the hard disk drive 308. Here, a MDL file for describing the dependence among functional blocks can be stored in the hard disk drive 308 in addition to the source code 404.

A parsing module 406 parses the received source code 404 and then converts the relation among functional blocks into graph representation. Data on the graph representation is preferably stored in the hard disk drive 308. A data structure of the graph representation on the computer is well-known, and thus description thereof is omitted here.

A strand forming module 408 reads the graph representation formed by the parsing module 406, and forms a strand for each integration block with the following method, but the method is not limited to this. Specifically, a strand is formed by tracing the flow of the block diagram from each integration block in a forward direction and setting, as a strand, a set of blocks found before (itself or another) integrated block is found.

This operation corresponds to an operation of taking out each ordinary differential equation from the block diagram.

A code generation module 410 generates source code to be compiled by a compiler 412 on the basis of information on strands formed by the strand forming module 408. As a programming language that the compiler 412 expects to receive, any programming language preferably such as C, C++, C#, Java (trademark) can be used. The code generation module 410 generates source code for each strand according to the received programming language.

Executable binary code (not shown) generated by the compiler 412 is executed in an execution environment 414 by an operation of the operating system.

According to the present invention, the entire simulation process is described as simultaneous ordinary differential equations formed of N ordinary differential equations as follows:

y′(t)=f(t,y(t))y,fεR^{N}

where t denotes time and y′(t) denotes first-order differentiation with respect to time t, and y and f generally denote n-dimensional vectors and are thus represented as follows:

y(t)≡(y^{[1]}(t),y^{[2]}(t), . . . ,y^{[N]}(t))^{T}

f(t,y(t))≡(f^{[1]}(t,y(t)),f^{[2]}(t,y(t)), . . . ,f^{[N]}(t,y(t)))^{T}.

The above equation is simultaneous ordinary differential equations when being expressed separately:

y′^{[1]}(t)=f^{[1]}(t,y(t))

y′^{[2]}(t)=f^{[2]}(t,y(t))

y′^{[3]}(t)=f^{[3]}(t,y(t))

. . . , and

y′^{[N]}(t)=f^{[N]}(t,y(t)).

Typically, one of the strands described above corresponds to the right-hand side of one equation y′^{[i]}(t)=f^{[i]}(t, y(t)) (i=1, . . . , N). In this specification, this computation process unit is referred to as a strand.

In other words, each strand executes a process for computing the right-hand side of y′^{[i]}(t)=f^{[i]}(t, y(t)), which is one of the ordinary differential equations of the simultaneous ordinary differential equations.

According to the control theory which is the basis of simulation, characteristic equations or response functions of a control system are written in the form of a parameter s of the Laplace transform. Since these result in ordinary differential equations in many cases, the assumption of this embodiment that simulation model is described as simultaneous ordinary differential equations is universal enough.

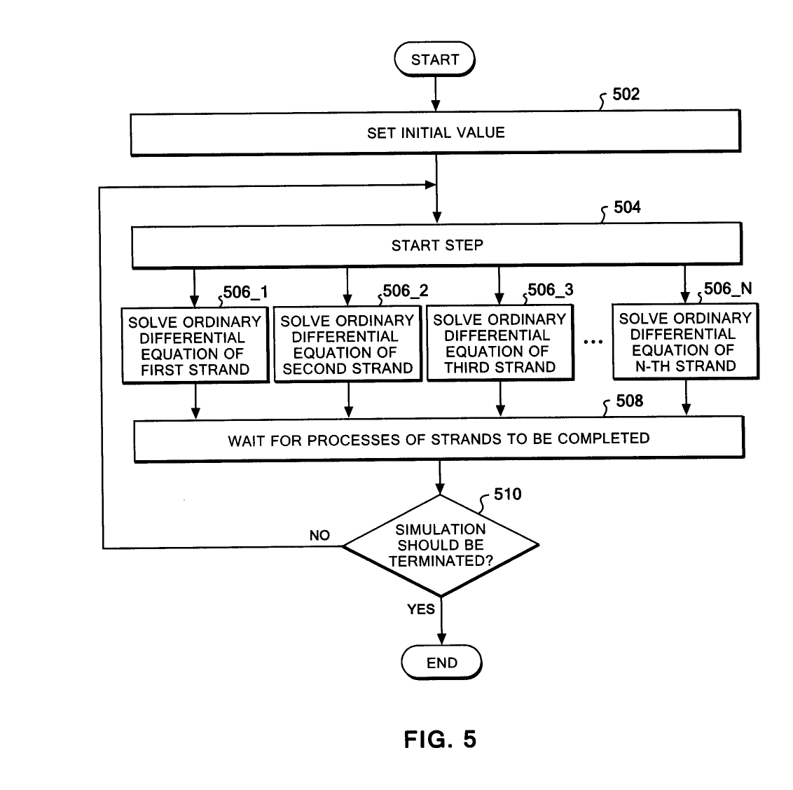

FIG. 5 is a schematic flowchart showing a process in which an executable module (not shown) generated by the compiler 412 in the execution environment 414 executes numerical computation for solving the simultaneous ordinary differential equations.

In order to execute the process of FIG. 5, according to this embodiment, execution code (not shown) for unifying the whole process is generated in addition to the code for solving each ordinary differential equation corresponding to one strand.

In Step 502 of FIG. 5, the execution code for management sets an initial value y(t₀) (at t=t₀) in the simultaneous ordinary differential equations, i.e., y′(t)=f(t, y(t)), y, fεR^{N}. This value is actually set by the operator in advance on the basis of simulation to be executed.

In Step 504, the execution code for management initiates strands 506_1, 506_2, 506_3, . . . , 506_N for solving the respective ordinary differential equations all at once and causes these strands to operate.

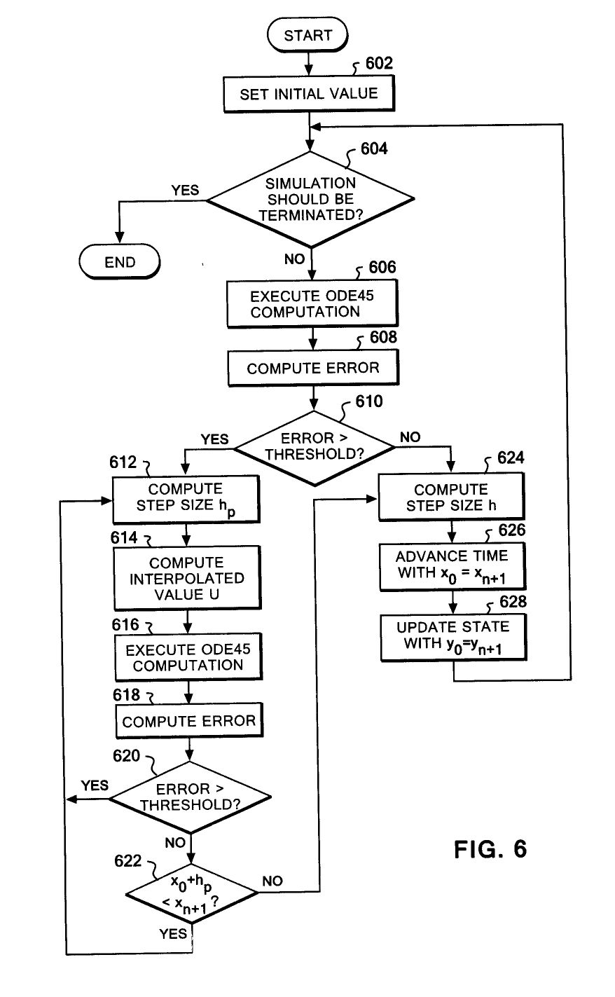

Once initiated, the strands 506_1, 506_2, 506_3, . . . , 506_N execute computation for solving the respective ordinary differential equations with the scheme of ODE45 including the feature of the present invention. The process of each of the strands 506_1, 506_2, 506_3, . . . , 506_N will be described in detail with reference to the flowchart of FIG. 6.

The execution code for management waits for all the processes of the strands 506_1, 506_2, 506_3, . . . , 506_N to be completed in Step 508. This is due to the following reasons. Specifically, the amount of computation required for the strands 506_1, 506_2, 506_3, . . . , 506_N is not always the same. Moreover, according to the feature of the present invention, each of the strands 506_1, 506_2, 506_3, . . . , 506_N can execute recomputation upon error detection, and thus the process thereof can be delayed due to the error in some cases.

After confirming in Step 508 that the computation for one time step of each of the strands 506_1, 506_2, 506_3, . . . , 506_N has been completed, the execution code for management determines in Step 510 whether or not the simulation should be terminated.

The termination of the simulation is determined by the event of an operation by the operator, completion of a planned scenario, a lapse of a predetermined length of time, or the like. If determining that the simulation should not be terminated, the execution code for management goes back to Step 504 to proceed to computation in a next time step. If determining that the simulation should be terminated, the execution code for management terminates the simulation.

Next, with reference to the flowchart of FIG. 6, description will be given for a computation process executed in each of the strands 506_1, 506_2, 506_3, . . . , 506_N.

As has been described in the background art, this embodiment is based on the assumption that simultaneous ordinary differential equations are solved through numerical computation by the computer using the ODE45 scheme of the Runge-Kutta-Fehlberg method.

Note that, the present invention is not limited to the Runge-Kutta-Fehlberg method of a certain order, but can employ other schemes such as ODE34 or ODE56. For further detailed description of the Runge-Kutta-Fehlberg method, refer to documents such as Ward Cheney, David Kincaid, “Numerical Mathematics and Computing,” Brooks/Cole Pub Co; 6th edition (Mar. 8, 2007).

In Step 602, the initial value set in Step 502 of FIG. 5 is set as a process condition of the ordinary differential equation for a certain strand.

In Step 604, it is determined whether the simulation should be terminated, and if so, the simulation is terminated. The process of Step 604 is substantially equal to or is executed in conjunction with the process of Step 510 of FIG. 5.

If it is determined that the simulation should not be terminated, the process proceeds to Step 606 and computation is executed in accordance with the ODE45 scheme. Concretely, the computation is executed as follows. Note that, the following description is given focusing on the ordinary differential equation y′^{[j]}(t)=f^{[j]}(t, y(t)) for the j-th strand here.

Here, a process is initiated on the assumption that x₀=xₙ.

k₁=hf(xₙ,yₙ)

k₂=hf(xₙ+a₂h,yₙ+b₂₁k₁)

k₃=hf(xₙ+a₃h,yₙ+b₃₁k₁+b₃₂k₂)

k₄=hf(xₙ+a₄h,yₙ+b₄₁k₁+b₄₂k₂+b₄₃k₃)

k₅=hf(xₙ+a₅h,yₙ+b₅₁k₁+b₅₂k₂+b₅₃k₃+b₅₄k₄)

k₆=hf(xₙ+a₆h,yₙ+b₆₁k₁+b₆₂k₂+b₆₃k₃+b₆₄k₄+b₆₅k₅)

where Xₙ denotes time, kᵢ (i=1, . . . , 6) denotes an intermediate variable, h denotes a step size (here, h is not a constant but a variable), and aᵢ, bᵢⱼ, cᵢ, and c*ᵢ (here, i and j are suffixes) are predetermined constants.

$${y}_{n + 1}^{[ j ]} = {y}_{n}^{[ j ]} + {\sum }_{i = 1}^{6} {c}_{i} {k}_{i} + O ( {h}^{6} ) \\ {y}_{n + 1}^{* [ j ]} = {y}_{n}^{[ j ]} + {\sum }_{i = 1}^{6} {c}_{i}^{*} {k}_{i} + O ( {h}^{5} ) \qquad [ Mathematical Formula 2 ]$$

In Step 608, an error Δ is computed by the following formula.

$$Δ ≡ {y}_{n + 1}^{[ j ]} - {y}_{n + 1}^{* [ j ]} = {\sum }_{i = 1}^{6} ( {c}_{i} - {c}_{i}^{*} ) {k}_{i} \qquad [ Mathematical Formula 3 ]$$

In Step 610, it is determined whether or not the error Δ thus computed is larger than a predetermined threshold Δ₀.

If Δ>Δ₀ is satisfied in Step 610, hₚ is computed by the following formula in Step 612. Note that, x₀+hₚ=xₙ₊₁ is satisfied if a value obtained by addition of x₀ and hₚ thus computed is larger than xₙ₊₁.

$${h}_{p} = h {\vert \frac{{Δ}_{0}}{Δ} \vert}^{0.2} \qquad [ Mathematical Formula 4 ]$$

Next, in Step 614, a fifth-order Hermite interpolated value U^{[i] of i=}1, . . . , N is computed in accordance with the following formula.

$$\begin{matrix}{U}^{[ i ]} ( {x}_{n} + {h}_{p} ) = {d}_{0} ( p ) {y}_{n}^{[ i ]} + {d}_{1} ( p ) {hf}_{1}^{[ i ] n - 1} + {d}_{2} ( p ) {y}_{n}^{[ i ]} + {d}_{3} ( p ) {hf}_{1}^{[ i ] n} + {d}_{4} ( p ) {hf}_{7}^{[ i ] n} + {d}_{5} ( p ) {hf}_{8}^{[ i ] n} \\ where & [ Mathematical Formula 5 ] \\ p = \frac{{h}_{p}}{h} & [ Mathematical Formula 6 ]\end{matrix}$$

Here, f^{[i]}ₗ is represented by the following formula.

$$\begin{matrix} {f}_{1}^{[ i ]} = {f}^{[ i ]} ( {x}_{n} + {c}_{1} h , {y}_{n}^{[ i ]} + h {\sum }_{j = 1}^{6} {b}_{1 j} {f}_{j}^{[ i ]} ) \\ Further , & [ Mathematical Formula 7 ] \\ {f}_{7}^{[ i ] n} = f ( {x}_{n} + 0.86 h , {u}_{0} ( {x}_{0} + 0.86 h ) ) \\ {u}_{0} ( {x}_{0} + 0.86 h ) = \frac{- 396851}{11250000} {y}_{n - 1}^{[ i ]} + \frac{3918031}{5000000} {y}_{n}^{[ i ]} + \frac{90601}{360000} {y}_{( n - 1 )}^{[ i ]} - h ( \frac{27391}{3750000} {f}_{1}^{[ i ] n - 1} + \frac{168259}{2500000} {f}_{1}^{[ i ] n} ) \\ {f}_{8}^{[ i ] n} = f ( {x}_{n} + 0.93 h , {u}_{0} ( {x}_{0} + 0.93 h ) ) \\ {u}_{0} ( {x}_{0} + 0.93 h ) = \frac{- 237699}{20000000} {y}_{n - 1}^{[ i ]} + \frac{75064671}{80000000} {y}_{n}^{[ i ]} + \frac{47089}{640000} {y}_{( n - 1 ) + 0.6}^{[ i ]} - h ( \frac{50127}{200000000} {f}_{1}^{[ i ] n - 1} + \frac{1997919}{40000000} {f}_{1}^{[ i ] n} ) \\ {d}_{0} ( p ) = {( p - 1 )}^{2} ( \frac{375}{64} {p}^{3} - \frac{8925}{1024} {p}^{2} + 2 p + 1 ) \\ {d}_{1} ( p ) = {p ( p - 1 )}^{2} ( \frac{5375}{3968} {p}^{2} - \frac{19062325}{8189952} p + 1 ) \\ {d}_{2} ( p ) = - {p}^{2} ( \frac{375}{64} {p}^{3} - \frac{20925}{1024} {p}^{2} + \frac{12949}{512} p - \frac{11997}{1024} ) \\ {d}_{3} ( p ) = ( p - 1 ) {p}^{2} ( \frac{199625}{6272} {p}^{2} - \frac{5385075}{100352} p + \frac{11997}{1024} ) \\ {d}_{4} ( p ) = {{p}^{2} ( p - 1 )}^{2} ( \frac{78125}{1568} p - \frac{47953125}{1078784} ) \\ {d}_{5} ( p ) = - {{p}^{2} ( p - 1 )}^{2} ( \frac{234375}{3083} p - \frac{8734375}{145824} ) & [ Mathematical Formula 8 ]\end{matrix}$$

Here, yₙ shown in the right-hand side of each of the formulae for k₁ to k₆ is actually yₙ≡yₙ(y^{[1]}, y^{[2]}, . . . , y^{[N]}) i.e., a function of y^{[1]}, y^{[2]}, . . . , y^{[N]}.

Thus, in Step 616, with the value obtained by the interpolant U^{[i]}(xₙ+hₚ) defined in the mathematical formula 5 being substituted for y^{[i]} (for each of i=1, . . . , N), the computation of ODE45 as in the case of Step 606 is executed starting from x₀+hₚ. For further detailed description of the interpolant U^{[i]}(xₙ+hₚ), refer to Non-patent Literature 1 above and so forth.

The strand j, in which an error has occurred, passes xₙ+hₚ to each of the corresponding strands i (rest of i=1, . . . , N excluding j). Then, the strand j collects values of U^{[i]}(xₙ+hₚ) (i=1, . . . , N) in such a manner that the rest of the strands i each compute the interpolant U^{[i]}(xₙ+hₚ) and send a resultant value back to the strand j.

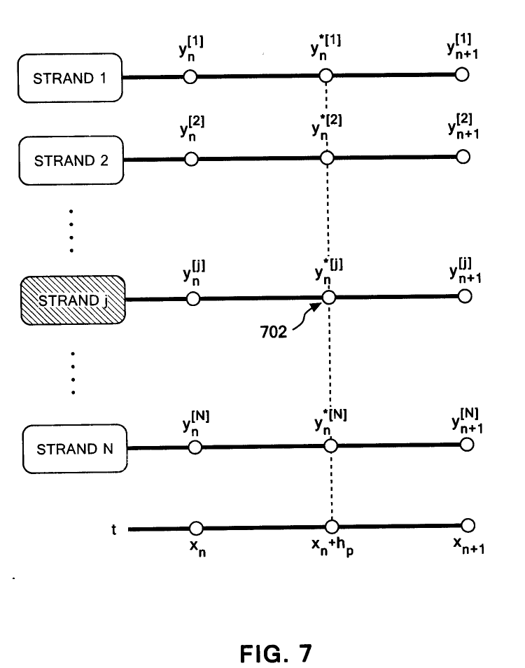

This process will be described later with reference to FIG. 7.

In Step 618, an error is computed with the same process as in Step 608. In Step 620, the error thus computed is compared with the threshold with the same process as in Step 610, and the process goes back to Step 612 if it is determined that the error is larger than the threshold.

If it is determined that the error is equal to or smaller than the threshold in Step 620, the process proceeds to Step 622.

In Step 622, it is determined whether or not x₀+hₚ<xₙ₊₁ is satisfied. If so, the process goes back to Step 612 to recompute hₚ. Then, the interpolated value U is computed in Step 614 on the basis of hₚ thus recomputed, and thereafter the computation of ODE45 is executed in Step 616.

According to the property of the error-computation formula of the Runge-Kutta-Fehlberg method, x₀+hₚ<xₙ₊₁ is always satisfied in Step 622 immediately after the process branches from Step 610 to Step 612. Then, a value of hₚ is incremented as the loop of Step 612, Step 614, Step 616, Step 618, Step 620, and Step 622 is iterated.

If x₀+hₚ is equal to xₙ₊₁, the process proceeds to Step 624 where a next step size h is computed with the following formula. Here, h on the right-hand side of the formula is replaced with hₚ.

$$h = h {\vert \frac{{Δ}_{0}}{Δ} \vert}^{0.2} \qquad [ Mathematical Formula 9 ]$$

In Step 626, the time is advanced with x₀=xₙ₊₁. Then, the state y₀ is updated with yₙ₊₁ in Step 628. Thereafter, the process goes back to Step 604 where the determination is made.

After the process proceeds again to Step 610 where the determination is made, if it is determined that the error Δ is equal to or smaller than the threshold Δ₀, the process goes back to Step 604 through Steps 624, 626, and 628 having been described above.

FIG. 7 is a timing chart schematically showing the operation of the strands 1 to N. Assume that an error occurs, i.e., error Δ>threshold Δ₀ is satisfied only in the strand j in Step 610 as a result of the computation for the strands 1 to N by the execution code.

While the time has reached xₙ₊₁ in each of the strands 1 to j−1 and the strands j+1 to N through Steps 624, 626, and 628, the strand j initiates the recomputation process from Step 612. The strand j computes an interpolated value in Step 614, but in this event can compute only the interpolated value for the self strand by itself. Hence, the strand j passes a value of x₀+hₚ to each of the strands corresponding to y^{[1]} shown in the right-hand side of the ordinary differential equation of the strand j, and receives computed interpolated values from the corresponding strands. Each of the strands uses the interpolant described in Step 614.

In FIG. 7, the interpolated values thus computed in the corresponding strands are shown as y*^{[1]}ₙ, y*^{[2]}ₙ, . . . , y*^{[N]}ₙ, respectively.

Each of the corresponding strands communicates with the strand j to send its interpolated value for the purpose of the recomputation. However, since only the strand j branches to a loop for the recomputation, almost no computation load is applied on each of the corresponding strands except for the load due to the computation of the interpolated value.

When only the strand j completes the recomputation, the time step of the strand j reaches the time step of other strands in Step 508 of FIG. 5, and the strand j is thus ready for computation in a next time step. Note that the computation for making the time step of the strand j equal to that of the other strands is practically executed in Step 612.

The present invention has been described on the basis of the above specific embodiment, but is not limited to this. For example, the schemes of any order, such as ODE34 and ODE56, of the Runge-Kutta-Fehlberg method can be employed in addition to ODE45. For the computation of an interpolated value in this case, the interpolant described in Non-Patent Literature 1 above can be used.

In addition, the present invention is not limited to the Runge-Kutta-Fehlberg method, but is also applicable to an embedded Runge-Kutta method which is a generalized version of the Runge-Kutta-Fehlberg method, such as the Dormand Prince method.

Further, an interpolant is not limited to the fifth-order Hermite interpolant shown in this example. Any interpolant can be used, such as a linear interpolant or the Newton interpolant, as long as it satisfies required accuracy.

Furthermore, the above embodiment has been described by taking a single processor as an example. However, the present invention is not limited to this. The technique of the present invention is also applicable to a system including multiple processors, such as a multiprocessor system or a multi-core system.

According to the present invention, when computing simultaneous ordinary differential equations in accordance with an embedded Runge-Kutta method such as the Runge-Kutta-Fehlberg method, a computer has only to execute recomputation of a strand in which an error larger than a threshold has occurred. This reduces the amount of computation, thus enabling a faster process.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

What is claimed is:

1. A method of solving simultaneous ordinary differential equations by a computer using an embedded Runge-Kutta method, the method comprising the steps of:
computing an error between a state value of order N (where N is a given integer) and a state value of order N+1 for each of ordinary differential equations of the simultaneous ordinary differential equations;
computing, in response to an event where the error exceeds a predetermined threshold, a step size by using the error and the threshold for the ordinary differential equation of the simultaneous ordinary differential equations;
computing an interpolated value corresponding to the computed step size for each of the ordinary differential equations associated with the ordinary differential equation having the error exceeding the predetermined threshold; and
recomputing the ordinary differential equation having the error exceeding the predetermined threshold by using the computed step size and the computed interpolated value.

2. The method according to claim 1, further comprising the step of receiving, in response to the event where the error exceeds the predetermined threshold, an interpolated value computed using the computed step size through a formula for each of the other ordinary differential equations of the simultaneous ordinary differential equations.

3. The method according to claim 2, wherein the embedded Runge-Kutta method is ODE45.

4. The method according to claim 1, wherein the embedded Runge-Kutta method is a Runge-Kutta-Fehlberg method.

5. The method according to claim 3, wherein the interpolant is a fifth-order Hermite interpolant.

6. An article of manufacture tangibly embodying computer readable instructions having an embedded Runge-Kutta method which, when implemented, cause a computer to carry out the steps of a method comprising:
computing an error between a state value of order N (where N is a given integer) and a state value of order N+1 for each of ordinary differential equations of the simultaneous ordinary differential equations through the process of the computer;
computing, in response to an event where the error exceeds a predetermined threshold, a step size by using the error and the threshold for the ordinary differential equation of the simultaneous ordinary differential equations through the process of the computer;
computing an interpolated value corresponding to the computed step size for each of the ordinary differential equations associated with the ordinary differential equation having the error exceeding the predetermined threshold through the process of the computer; and
recomputing the ordinary differential equation having the error exceeding the predetermined threshold through the process of the computer by using the computed step size and the computed interpolated value.

7. The article of manufacture according to claim 6, further comprising the step of receiving, in response to the event where the error exceeds the predetermined threshold, an interpolated value computed using the computed step size through a formula for each of the other ordinary differential equations of the simultaneous ordinary differential equations.

8. The article of manufacture according to claim 7, wherein the embedded Runge-Kutta method is ODE45.

9. The article of manufacture according to claim 6, wherein the embedded Runge-Kutta method is a Runge-Kutta-Fehlberg method.

10. The article of manufacture according to claim 8, wherein the interpolant is a fifth-order Hermite interpolant.

11. A system for solving simultaneous ordinary differential equations through a process of a computer by using an embedded Runge-Kutta method, the system comprising:
means for computing an error between a state value of order N (where N is a given integer) and a state value of order N+1 for each of ordinary differential equations of the simultaneous ordinary differential equations through the process of the computer;
means for computing, in response to an event where the error exceeds a predetermined threshold, a step size by using the error and the threshold for the ordinary differential equation of the simultaneous ordinary differential equations through the process of the computer;
means for computing an interpolated value corresponding to the computed step size for each of the ordinary differential equations associated with the ordinary differential equation having the error exceeding the predetermined threshold through the process of the computer; and
means for recomputing the ordinary differential equation having the error exceeding the predetermined threshold through the process of the computer by using the computed step size and the computed interpolated value.

12. The system according to claim 11, further comprising the means for receiving, in response to the event where the error exceeds the predetermined threshold, an interpolated value computed using the computed step size through a formula for each of the other ordinary differential equations of the simultaneous ordinary differential equations.

13. The system according to claim 12, wherein the embedded Runge-Kutta method is ODE45.

14. The system according to claim 11, wherein the embedded Runge-Kutta method is a Runge-Kutta-Fehlberg method.

15. The system according to claim 13, wherein the interpolant is a fifth-order Hermite interpolant.
